(19) United States
(12) Patent Application Publication
(10) Pub. No.: US 2024/0083200 A1
(43) Pub. Date: Mar. 14, 2024

(54) TYRE MONITOR

(71) Applicant: AIRBUS OPERATIONS LIMITED, Bristol (GB)

(72) Inventor: Andrew BILL, Bristol (GB)

(21) Appl. No.: 18/257,701

(22) PCT Filed: Dec. 15, 2021
(86) PCT No.: PCT/EP2021/085849

§ 371 Date: Jun. 15, 2023

(30) Foreign Application Priority Data
Dec. 15, 2020 (GB) 2019750.5
Dec. 15, 2020 (GB) 2019753.9
Dec. 16, 2020 (GB) 2019868.5

(51) Int. Cl. B60C 23/04

(52) U.S. Cl. CPC B60C 23/0411; B60C 2200/02

(57) ABSTRACT

A tyre monitor is disclosed including a sensor device configured to operate within an enclosed space formed by the wheel and the tyre, and an energy harvester unit. The energy harvester is arranged to convert a first type of energy experienced by the harvester unit in use (e.g. mechanical energy, thermal energy) into electrical energy to energise the sensor device. The energy harvester may be, for example, a piezoelectric device or a thermoelectric generator. In use, mechanical stresses experienced by the tyre monitor are converted into electrical energy which can be used to energise the sensor as a supplement to energy from the battery within the tyre monitor, thus prolonging its service life.

### FIELD OF TECHNOLOGY

This invention relates to a device arranged to monitor an operating parameter of a tyre, such as an aircraft tyre. The invention also relates to a tyre including a monitoring device; to an aircraft incorporating a tyre monitoring device; and to a kit of parts including such a tyre monitoring device.

### BACKGROUND

Checking tyre pressure is an important part of the maintenance of an aircraft. Tyre pressures should be maintained within a range of predetermined values to ensure that a tyre performs as intended. The benefits of proper inflation of aircraft tyres are well known. Under inflation produces uneven tread wear and shortens tire life due to excessive flex heating. It is imperative that the pressure of aircraft tyres is monitored regularly and frequently.

Currently, many such checks of aircraft wheel assembly properties are performed manually by using, for example, a manometer or other pressure gauge. Automated systems exist for monitoring tire pressure, but these systems require a pressure sensor to be permanently installed on a wheel in a manner specific to the particular design of the wheel. For instance, the wheel must typically include a port to accommodate the sensor, and possibly also a counterweight feature.

A problem which may be encountered with mounting the pressure sensor on the wheel is that the aircraft wheel is a hostile environment, subjected to the elements and to debris on the runway and hence may become damaged in use.

It has been proposed to install a tyre monitor within the tyre, together with a wireless communication interface arranged to transmit readings from the tyre monitor to an external reader. However, such a system needs to be energised by batteries, which have a limited life. The removal and replacement of batteries involves dismounting and dismantling the tyre, which involves a considerable amount of time and effort.

### BRIEF SUMMARY OF THE TECHNOLOGY

The invention provides a tyre monitor comprising a sensor device arranged to detect an operating parameter of a tyre mounted on a wheel, the sensor device being configured to operate within an enclosed space formed by the wheel and the tyre; and an energy harvester unit arranged to convert a first type of energy experienced by the harvester unit in use into electrical energy to energise the sensor device.

The provision of an energy harvester permits energy to be generated by the mechanical stresses experienced by the monitor in use. Such energy can be used to energise the sensor as a supplement to energy from the battery within the tyre monitor, thus prolonging the service life of the tyre monitor.

Preferably, the energy harvester unit is also arranged to convert a second type of energy experienced by the harvester unit in use into electrical energy to energise the sensor device. Thus, energy can be harvested from the wide variety of operating conditions experienced by the tyre monitor.

Advantageously, the harvester unit includes at least one harvester arranged to convert mechanical energy into electrical energy. Thus, the sensor device can be energised by virtue of the motion experienced by the tyre monitor itself when in use inside the tyre.

Optionally, the at least one harvester comprises a piezoelectric device.

The harvester may preferably be arranged to convert mechanical stress experienced along orthogonal axes into electrical energy.

The harvester unit may advantageously include at least one thermoelectric device arranged to convert thermal energy into electrical energy.

An energy storage device is preferably provided, which device may include at least one battery and/or at least one capacitor.

A wireless communication interface may be provided and arranged to communicate with a device external to the sensor device.

Preferably, a power management module is provided and arranged to manage power between the energy harvester unit, the energy storage device, the wireless communication interface and the sensor.

The sensor preferably comprises a pressure sensor for measuring the internal pressure of a tyre. Alternatively, or additionally, a temperature sensor arranged to measure a temperature within a tyre may be provided.

The tyre monitor may further comprise a resiliently flexible housing substantially surrounding the sensor device, with the housing comprising an elastic material and the tyre monitor being able to move freely when installed in a tyre.

The sensor device may be fixedly attached to a movable retaining ring configured to be movably attached to a circumferential surface of the wheel such that relative circumferential movement between the ring and the wheel is permitted.

The ring may have spaced end portions, and the ring may be resiliently biased either radially outwardly or radially inwardly.

The energy harvesting unit may be arranged on the retaining ring at a location spaced from the sensor device.

The invention further provides a wheel assembly including a tyre monitor constructed according to the invention.

The invention may be realised as a kit of parts comprising the tyre monitor and a reader external to the tyre monitor, wherein the sensor device and the reader are configured to communicate with each other.

The invention further provides an aircraft including the tyre monitor. A plurality of wheel assemblies and a plurality of tyre monitors may be provided, each tyre monitor being associated with a different respective wheel assembly.

### BRIEF DESCRIPTION OF THE DRAWINGS

The invention will now be described, by way of example, with reference to the accompanying drawings in which:

FIG. 1 is a front view of an aircraft;

FIG. 2 is a front perspective view of parts of a wheel of the aircraft of FIG. 1;

FIG. 3a is a side view of a tyre monitor constructed according to the invention;

FIG. 3b is a front view of a wheel assembly including the tyre monitor of FIG. 3a;

FIG. 3c is a side view of a wheel assembly including the tyre monitor of FIG. 3a;

FIG. 4 is a schematic diagram of the tyre monitor of FIG. 3a;

FIG. 5 is a sectional view of an alternative tyre monitor constructed according to the invention;

FIG. 6 is a schematic view of a tyre monitor constructed according to an alternative embodiment of the invention; and

FIG. 7 is a schematic view of a tyre monitor constructed according to another embodiment of the invention.

Like reference numerals refer to like parts throughout the specification.

### DETAILED DESCRIPTION OF EMBODIMENTS OF THE TECHNOLOGY

In examples described herein, references to “aircraft” include all kinds of aircraft, such as fixed wing military or commercial aircraft; unmanned aerial vehicles (UAVs); and rotary wing aircraft, such as helicopters.

The components shown in the drawings are not necessarily shown to scale.

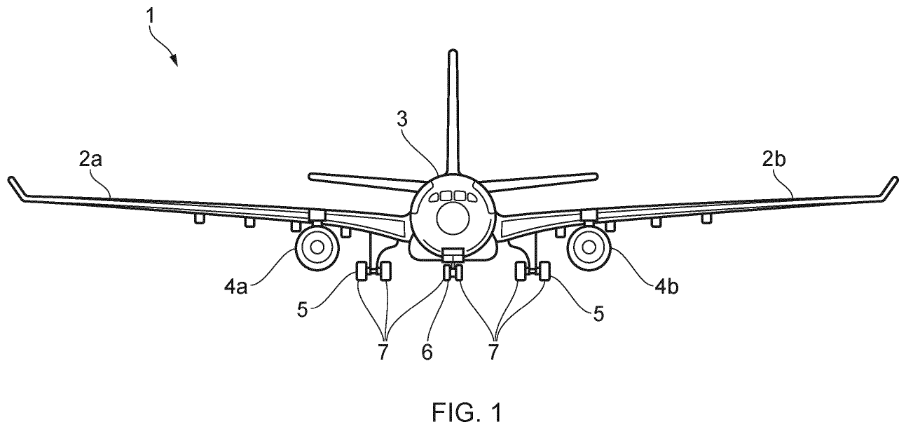

With reference to FIG. 1, an aircraft indicated generally by the reference numeral 1 comprises a pair of wings 2a, 2b and a fuselage 3. The wings 2a, 2b each carry an engine 4a, 4b respectively. The aircraft 1 is supported on the ground by sets of landing gear assemblies comprising a main landing gear (MLG) 5 and a nose landing gear (NLG) 6. The landing gear assemblies comprise pairs of wheel assemblies 7 which are shown in FIG. 1 in contact with the ground (e.g. a runway). This aircraft has six wheel assemblies in total; four wheel assemblies as part of the MLG 5 and two wheel assemblies as part of the nose landing gear NLG 6. The aircraft therefore needs six tyre monitoring devices. Other models of aircraft may have different numbers of wheel assemblies and hence different numbers of tyre monitoring devices.

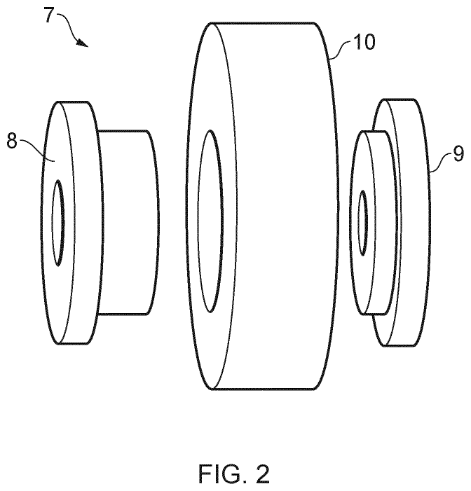

FIG. 2 is a simple diagram showing the basic construction of an aircraft wheel assembly 7. The wheel assembly 7 comprises an inboard wheel rim 8, an outboard wheel rim 9 and a tyre 10. The inboard wheel rim 8 houses the brake assembly (not shown) for the wheel assembly 7. The outboard wheel rim 9 includes a valve (also not shown) for inflating the tyre 10. To construct the wheel assembly 7, the wheel rims 8, 9 are bolted together with the tyre 10 in-between which is then pressurised via the valve, usually with nitrogen.

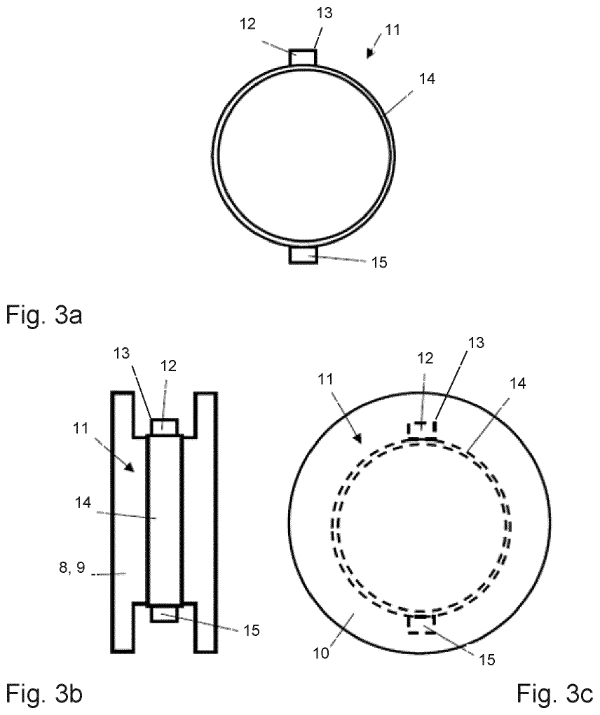

A tyre monitor 11, as shown in FIGS. 3a-3c, is provided inside the tyre 10. The tyre monitor comprises a tyre sensor device 12 in a protective housing 13, disposed on a mounting band or ring 14.

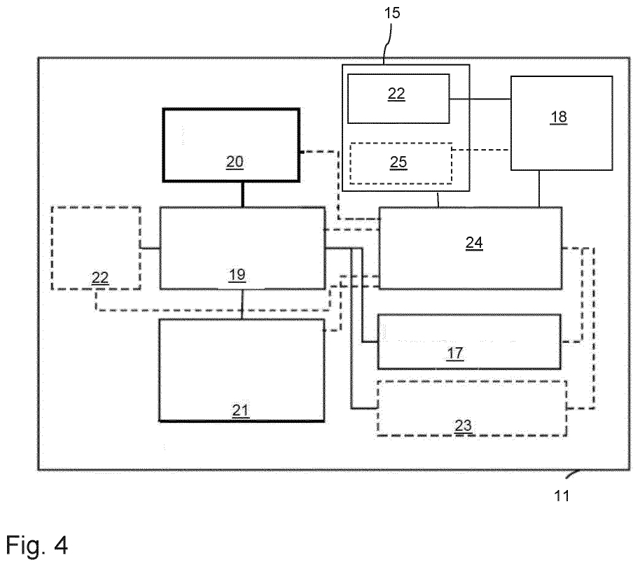

The sensor device 12 is configured to acquire measurement data. The sensor device 12 may be configured to acquire a single type of measurement data, or multiple types of measurement data. The sensor device 12 may comprise a set of multiple sensors, each of which may be configured to independently acquire measurement data. Each sensor in the set may acquire a different type of measurement data, or two or more sensors in the set may acquire the same type of measurement data. The tyre monitor 11 also comprises other components that are operationally related to the sensor device 12. These further components are described in more detail below with reference to FIG. 4.

The tyre monitor 11 may be mounted on such an aircraft wheel assembly before the inboard and outboard wheel rims 8, 9 are bolted together, for example by axially sliding the mounting band onto the hub part of one of the wheel rims 8,9. The inboard and outboard wheel rims 8, 9 are then bolted together once the mounting member is in place on the hub part. The mounting band 14 is configured to engage with the rims 8, 9 of the wheel assembly 7 in a manner such as to retain the tyre monitor 11 on the wheel, as shown in FIGS. 3b and 3c. The mounting band 14 is arranged to allow the tyre monitor 11 to move around the circumference of the wheel. Thus, the sensor device 12 is able to remain substantially stationary (ignoring any translational motion of the wheel assembly 10 that may be occurring) when the wheel assembly 7 is rotating relatively slowly (a relatively slow rotation rate of the wheel may occur, for example, during taxiing of an aircraft on which the wheel assembly is installed). At relatively high rotation rates (as may occur, for example, during take-off and landing of an aircraft on which the wheel assembly is installed) the centrifugal force felt by the tyre monitor 11 will cause it to rotate together with the wheel.

The inner circumferential surface of the movable mounting band 14 and the circumferential surface of the wheel rims 8, 9 are mutually configured to facilitate sliding therebetween. For example, the inner circumferential surface of the movable mounting band 14 and the circumferential surface of the wheel may be mutually configured to ensure a low coefficient of friction therebetween. One or both of the inner circumferential surface of the mounting band 14 and the circumferential surface of the wheel rims 8, 9 may comprise a low-friction coating.

In accordance with the invention, the tyre monitor 11 further comprises an energy harvester unit 15 on the mounting band 14. In this embodiment of the invention, the energy harvester unit 15 comprises a mechanical energy harvester in the form of a piezoelectric device that is capable of converting mechanical stress into electrical power. The piezoelectric device may comprise a piezoelectric layer encapsulated between two electrodes, where power is generated upon bending of the energy harvester. The piezoelectric device may alternatively (or additionally) comprise piezoelectric fibres embedded in a matrix. The piezoelectric device can be configured to generate power mechanically by rotation of the tyre, vibration of the wheel assembly and/or deformation as the harvester unit 15 moves around inside the wheel assembly.

Any known piezoelectric material may be employed in the energy harvester, such as piezoelectric crystals (e.g. quartz, gallium orthophosphate) or piezoelectric ceramics (e.g. sodium tungstate, bismuth ferrite). Some polymers, such as polyvinylidene fluoride (PVDF) can also exhibit piezoelectricity. Piezo polymers advantageously provide a higher elastic modulus but lower piezoelectric coefficient (and therefore lower generated energy) in comparison to crystals or ceramics. Therefore, a combination of piezoelectric materials may be employed.

In this embodiment, the sensor device 12 is fixedly attached to the mounting band 14 at a first circumferential location, and the energy harvester unit 15 is fixedly attached to the band 14 at a second, different circumferential location diametrically opposite the sensor device. This is advantageous to balance the wheel assembly 7.

As the tyre rotates, rotational movement, vibration and/or impacts experienced by the harvester unit 15 are converted by the harvester into electricity employed to energise the sensor device 12 and its associated components. The mounting band 14 includes electrical conductors arranged to transmit electrical energy from the harvesting unit 15 to the sensor device 12. Power may be transmitted from the harvesting unit 15 to the sensor device 12 by means of conductors embedded in, or attached to, the band. Alternatively, the band itself may form the electrical conductor between the harvester unit 15 and the rest of the tyre pressure sensing device 12.

The tyre monitor 11 is shown schematically in FIG. 4. The tyre monitor 11 comprises the pressure sensor device 12 including the following components: a pressure sensor 17; a processor 19; a memory unit 20; and a wireless communication interface 21. The tyre monitor 11 also comprises the energy harvester unit 15 comprising a first type of energy harvester 22. A power supply 18 and a power management module 24 are also provided, and these may be located in the pressure sensor device 12 or in the energy harvester unit 15. The tyre monitor 11 may optionally include some or all of the following components (shown in broken lines in this drawing): a time source 22; a temperature sensor 23; and at least one further energy harvester 25.

The pressure sensor 17 may be any suitable sensor for measuring gas pressure inside an aircraft tyre, for example a resistive sensor or a capacitive sensor. The pressure sensor 17 is connected to the processor 19 and provides signals to it indicative of the internal inflation pressure of the tyre. The processor 19 may be any suitable processing device, such as a microprocessor with one or more processing cores. In use, the processor 19 coordinates and controls the other components and may be operative to read and/or write computer program instructions and data from/to the memory unit 20. The processor 19 may be arranged to encrypt data for transmission.

The power management module 24 is arranged to convert the irregular energy flow from the energy harvester unit 15 into regulated energy suitable for use directly by the pressure sensor 17 and associated components and/or for storage for longer-term use in the power supply 18. The power supply 18 may be a rechargeable battery (for example, a lithium ion battery) or a capacitor. A combination of at least one battery with one or more capacitors may be employed and regulated by the power management module 24. A battery is advantageously able to store electrical charge for prolonged periods; however, the storage capacity of a capacitor is less likely to degrade with multiple cycles of energising and de-energising over time. The power management module 24 and/or the power supply 18 may be located on the band 14 in the energy harvesting unit 15 or in the sensor device package 12, 13, in dependence on the balance requirements of the components attached to the mounting band 14. The electrical conductors of (or in) the mounting band 14 provide for the transmission of electrical energy to the components packaged in the sensor device 12, 13.

An optional further energy harvester 25 may be provided. This energy harvester 25 may be of the same type as the energy harvester 22, or may be different. The further harvester 25 may be arranged to convert a different type of energy into electrical energy. For example, the harvester 25 may comprise a thermoelectric generator. A thermoelectric generator is a device that converts heat flux (temperature differences) directly into electrical energy through a phenomenon called the Seebeck effect. The thermoelectric generator may take the form of an array of thermocouples on one or more substrates, or as a thermoelectric material. The electricity delivered by the thermoelectric generator increases with increasing temperature difference. It has been discovered that the efficiency of such thermoelectric generators may be markedly increased by the use of so-called topological materials, such as tin telluride, which may be formed as thin film sheets, nanowires or nanoribbons.

In use, the energy harvester 25 of the tyre monitor 11 will be subject to temperature differences because of the variety of operating conditions of the wheel assembly 7. Such operating conditions will set up temperature gradients within the tyre and hence the (or each) thermoelectric generator, resulting in electrical energy being produced.

More than one further energy harvester 25 may be employed. It may be advantageous to have a plurality of small energy harvesters rather than one or two larger ones. It may also be advantageous to have multiple energy harvesters of different types in order to harvest energy from the variety of conditions experienced inside the wheel assembly 7 in use.

In use, the tyre monitor 11 may spend some of its operational life in “sleep” or low power mode, with most of the components other than the processor 19 and wireless communication interface 21 powered off. This can conserve energy. For example, the tyre pressure sensor device 12 may be by default in a low power mode, listening for a command to measure or report tyre pressure.

The memory unit 20 is connected to the processor 19 and is used to store computer program instructions for execution by the processor; and data, such as data from the pressure sensor 17 or data received over the wireless communication interface 21. The memory unit 20 can include non-volatile rewritable storage, such as flash memory which can retain data without requiring applied power. Alternatively, volatile storage, which is kept powered by the power supply 18, may be employed; or combinations of read-only and rewritable storage.

The memory unit 20 is configured to store a history of pressure readings sensed by the pressure sensor 17. The history may be stored for at least the maximum time between pressure measurements for tyre maintenance, such as for at least three days. This can ensure that enough history is held to provide details since the last maintenance tyre pressure reading, so that the history can be transferred for use in trend analysis, along with the current pressure measurement data. Longer periods of history may also be kept.

The wireless communication interface 21 is connected to the processor 19 and is used to both transmit data to, and receive data from, other devices within a tyre pressure sensor system, which is described in more detail later in the specification. The wireless communication interface 21 includes at least one transceiver. More than one transceiver may be provided, each using different wireless technology and/or arranged to transmit and receive over different ranges.

As mentioned above, the device may also include a temperature sensor 23 connected to the processor and arranged to take reading of the temperature of the gas inside the tyre directly. Data from the temperature sensor 23 may also be stored in the memory unit 20. The temperature sensor 23 may be any suitable sensor for measuring gas temperature within a tyre, such as a thermocouple. Knowing gas temperature enables direct temperature compensation of pressure measurements to be carried out-there is no need to wait for the wheels to cool.

Furthermore, the device may optionally include a time source 22, such as a counter or a real time clock. The time source 22 provides a value indicative of current time for indicating the time at which a measurement was taken; for example the processor 19 may cause a current value of the time source 22 to be associated with each pressure and/or temperature measurement when it is stored in the memory unit 20 for use as a time stamp.

Measurements of tyre pressure can be taken at regular intervals to obtain historical data of pressure without requiring operator input and stored with an associated time of measurement or time stamp. When the tire monitoring device 11 also includes a temperature sensor, temperature data can also be stored along with the pressure data. A history of pressure/temperature pairs with an associated time stamp can therefore be built up over time. Such historical data can be used to improve the reliability of tyre pressure measurement and enable improved tyre maintenance

As mentioned above, the wireless communication interface 21 is arranged to communicate data with other devices in a tyre pressure monitoring system. For example, the wireless communication interface 21 may be arranged to communicate with an indicator on its tyre arranged to provide indications to ground crew of the condition of that tyre. A suitable indicator would be a visual indicator such as a light signal arranged to emit light indicative of the tyre's condition—for example, a constant light, a flashing light, light of a first colour and/or a second colour. Other visual indicators are an LCD or e-ink display. An audible indicator such as a buzzer or speaker, may alternatively or additionally be provided.

Alternatively, the wireless communication devices of the tyres of an aircraft may be arranged to communicate with each other and to provide an output to a single indicator device. For example, there may be a light signal on the NLG, arranged to emit green light if all tyres are within an acceptable range of pressure values, but to emit red light if any one of the tyres requires maintenance or further checks. Such an arrangement reduces the need for ground crew to walk around to each wheel. Other visual or audible indicators may be provided on the NLG.

The wireless communication devices of the tyre assemblies may be in communication with a cockpit system to provide tyre pressure and/or temperature data to the pilots on the flight deck. Alternatively, or additionally, the wireless communication interfaces may be arranged to communicate with a handheld device, such as a tablet, smart phone or portable computer. Thus, ground crew can download data from one or more tyre pressure sensor devices, or even all of the tyre pressure sensor devices for analysis.

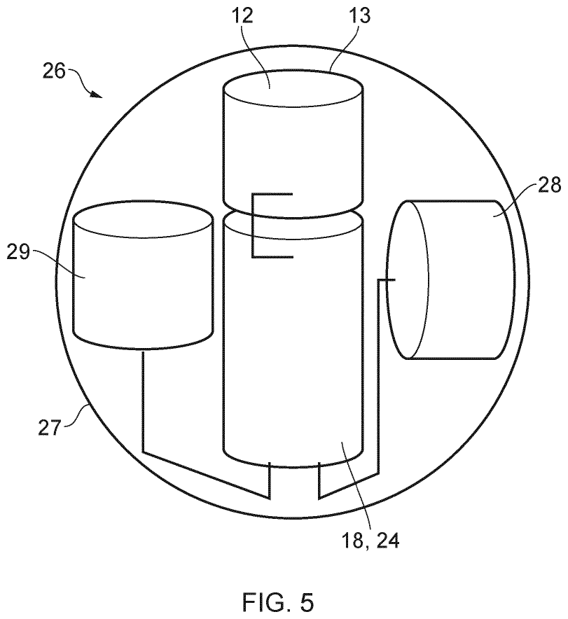

FIG. 5 shows a tyre monitor 26 constructed according to an alternative embodiment of the invention. The tyre monitor 26 comprises a tyre pressure sensor device 12 similar to that described above with reference to FIGS. 3 and 4. The pressure sensor device is located in a casing 13 inside a protective, resiliently flexible housing 27 formed from an elastic material. In this embodiment, the housing 27 is formed from a thick layer of silicone rubber that is able to withstand the extremes of temperature that are experienced in the tyre (typically between −55° C. to 275° C.). The housing 27 has a spherical outer surface and vents (not shown) which, provide a fluid flow path between the tyre pressure sensor device 12 and the environment outside the housing 27 so that, when the monitor 11 is in use, the device 12 can sense the gas pressure and/or temperature of the monitor's surroundings.

The housing 27 serves to protect the contents of the casing 13 from impact and vibration, and also protects the tyre 10 and rims 8, 9 of the wheel assembly 7 from impact with the casing 13. Installation of the tyre monitor 26 is very simple and intuitive: the operator simply places the tyre monitor inside the tyre 10 prior to inflation. The tyre monitor 26 is not attached to any part of the wheel assembly 7 and is not constrained in its movements within the tyre. Thus, in use, the tyre monitor 26 is free to roll, travel and bounce within the envelope of the tyre. In use, the housing 27 bounces and flexes with movement of the tyre 10 on the ground. The tyre monitor 26 is sufficiently flexible to allow the tyre 10 to flex and deflect freely, so that the performance of the tyre on the ground is not compromised.

In accordance with the invention, an energy harvesting unit is provided—here in the form of two piezoelectric devices 28, 29. Each of the devices 28, 29 is arranged to convert mechanical stress experienced along a specific axis into electrical energy to energise the sensor device 12. The two axes shown here are orthogonal. Of course, a third piezoelectric device may be provided and arranged to convert mechanical stress experienced along a third axis, orthogonal to the other two, into electrical energy. As mentioned above, the housing 27 of the tyre monitor 26 bounces and flexes in use, and the resulting motion, flexing and vibration causes electrical energy to be induced in the energy harvesting devices 28, 29. This electrical energy is supplied to a power supply 18 and power management module 24 and hence to the (or each) sensor in the sensor package 12, 13.

The housing 27 itself may be formed from piezoelectric material, made by embedding high dielectric constant piezoelectric materials in resins or rubber compounds, so that the housing itself becomes an energy harvesting device. Alternatively (or additionally), the housing 27 may be formed from a topological material. The housing 27 need not have a spherical outer surface: any suitable shape, such as a cuboid or polyhedron, may be employed. Where the tyre monitor 26 includes a plurality of piezoelectric devices, they need not be arranged along orthogonal axes.

More than one tyre monitor 26 may be installed into a wheel assembly 7, each being able to move independently within the tyre. The energy harvesting unit in each tyre monitor 26 need not be of the same type: for example, one tyre monitor could include a piezoelectric device, while another could include a thermoelectric generator.

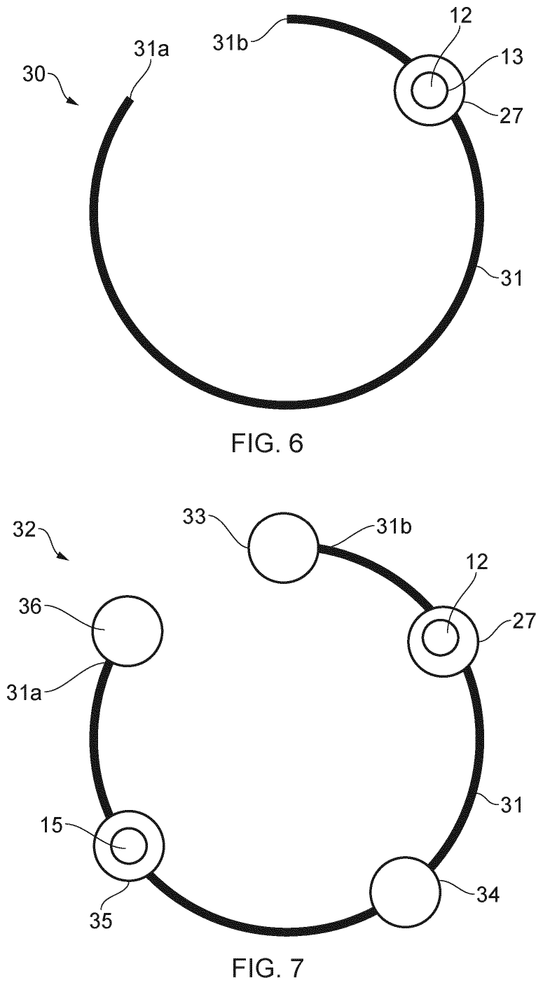

A further alternative embodiment of the invention is shown in FIG. 6. In this embodiment, a tyre monitor 30 comprises a tyre pressure sensor device 12 in a casing 13, the casing being at least partially surrounded by a protective, resiliently flexible housing 27 similar to that shown in FIG. 5.

The flexible housing is attached to a retaining ring 31 that has two spaced apart end portions 31a, 31b. The housing may be attached to the ring 31 by use of a suitable adhesive, bonding, moulding or fastening process. The retaining ring 31 is formed of steel and is resiliently biased, either radially outwardly or inwardly, such that the end portions 31a, 31b have a tendency to move away from, or towards, each other respectively.

The end portions 31a, 31b of the ring are intended to be gripped by an installation technician when installing the tyre monitor 11. The technician holds the end portions 31a, 31b, and urges them against the direction of bias. Then, the technician places the tyre monitor 11 inside the tyre 10 and releases the end portions 31a, 31b so that the ring 31 expands or contracts into the tyre and resumes its initial shape. The wheel rim portions 8, 9 are then assembled on the tyre 10 and bolted together, and the tyre is pressurised.

In accordance with the invention, an energy harvesting unit 15 is provided for the tyre monitor 30 and arranged to generate electrical energy to energise the sensor device 12. This unit may be similar to those described above with reference to FIGS. 3, 4 and 5. The energy harvesting unit of the tyre monitor 30 experiences different types of mechanical stress in dependence on the direction of bias of the ring 31. For example, if the ring 31 is radially outwardly biased, the housing 27 tends to make contact with the inner surface of the tyre's circumference i.e. at its running surface. In use, the housing 27 and retaining ring 31 flex with movement of the tyre 10 on the ground. Such motion induces electrical energy in the energy harvesting unit 15 as aforementioned. Alternatively, the ring 31 may be biased radially inwardly, in which case the flexible, resilient housing 27 is in contact with the rims 8, 9 of the wheel assembly 7. In use, the housing 27 and retaining ring 31 absorb vibrations of the rim 8, 9 and the energy harvester 15 converts such vibrations into electrical energy.

The flexible ring 31 itself may be employed as an energy harvester. For example, as the ring bends and flexes as the tyre moves, the mechanical stresses set up within it can be converted into electrical energy by, for example, a piezoelectric device. The piezoelectric device may be located on the circumference of the ring 31 or may be embedded within it. This may be used as the sole energy harvester or to complement the energy harvester(s) located in the housing 27. Alternatively, or additionally, a thermoelectric generator may be located on or embedded in the ring 31, in order to convert the temperature gradient experienced by the ring into electrical energy.

In the further embodiment of FIG. 7, the tyre monitor 32 includes a tyre pressure sensing device 12 in a casing, the casing being at least partially surrounded by a protective, resiliently flexible housing 27 similar to that shown in FIGS. 5 and 6. A plurality of dampers 33-36 are also provided on the retaining ring 31. The dampers 33-36 are formed from a resiliently flexible material, such as the silicone rubber used for the housing 27. They are arranged on the ring 31 in a weight-balanced configuration, so as not to detrimentally effect the balance of the aircraft wheel assembly. The dampers 33-36 are arranged to absorb impact experienced by the tyre monitor 32 in use.

In accordance with the invention, the tyre monitor 32 includes an energy harvesting unit 15, similar to those described above. In this drawing, the energy harvesting unit 15 is located inside damper 35 so as to balance the components in the pressure sensor device 12. Power may be transmitted from the harvesting unit 15 to the sensor device 12 by means of conductors embedded in, or attached to, the ring 31. Alternatively, the ring 31 itself may form the electrical conductor between the harvester unit 15 and the rest of the tyre pressure sensing device 12. Furthermore, the ring 31 may itself be employed as an energy harvester as described above.

Furthermore, any or all of the dampers 33, 34, 36 may be arranged to include at least one energy harvesting device of any type. The dampers 33-36 may also be arranged to house other components of the tyre monitor 32, with a power management module being arranged to control the supply of power between them along the conductors in the ring 31.

Two of the dampers 36, 33 may be provided at the respective end portions 31a, 31b of the retaining ring 31. As well as potentially housing energy harvesting devices, these dampers also serve to protect the tyre 10 and rim 8, 9 from the ends of the ring 31a, 31b in use. They may also provide useful hand grips so that a technician can easy pull or push the end portions of the ring when installing or removing the tyre monitor 32. To this end, the dampers 33, 36 may be shaped to provide a comfortable hand grip for the user. The method of installing this embodiment of the tyre monitor is the same as that described for the monitor of FIG. 6.

Variations may be made without departing from the scope of the invention. For example, other types of energy harvester may be provided as an alternative, or in addition to, the ones described above. Electrostatic or electromagnetic devices may be employed. Multiple micropower generators of different types may be utilised.

The retaining ring 31 need not be of steel: other robust yet flexible materials could be employed, such as carbon fibre composite. The retaining ring could also be used as an antenna for the wireless communication interface. The retaining ring may be arranged to be more flexible in the embodiments that are biased outwardly towards the tyre (that need to tolerate tyre deflection), than in the embodiments arranged to contact the rim.

The sensor device 12 may be configured to acquire any or all of the following types of measurement data: tire gas temperature; tire pressure; distance between the sensor and a part of the wheel assembly; distance between the sensor and a surface on which the wheel assembly is supported; acceleration; acoustic noise data; vibration data. The sensor 12 may be configured to use any suitable known sensing technology to acquire the measurement data, depending on which type(s) of measurement data the sensor 12 is intended to acquire. Further variations will be apparent to the skilled person.

1. A tyre monitor, comprising:
a sensor device configured to detect an operating parameter of a tyre mounted on a wheel, the sensor device is configured to operate within an enclosed space formed by the wheel and the tyre; and
an energy harvester unit arranged to convert a first type of energy experienced by the harvester unit in use into electrical energy to energise the sensor device.

2. A tyre monitor as claimed in claim 1, in which the energy harvester unit is also arranged to convert a second type of energy experienced by the harvester unit in use into electrical energy to energise the sensor device.

3. A tyre monitor as claimed in claim 1, in which the harvester unit includes at least one harvester arranged to convert mechanical energy into electrical energy.

4. A tyre monitor as claimed in claim 3, in which the at least one harvester comprises a piezoelectric device.

5. A tyre monitor as claimed in claim 3, in which the harvester is arranged to convert mechanical stress experienced along orthogonal axes into electrical energy.

6. A tyre monitor as claimed in claim 1, in which the harvester unit includes at least one thermoelectric device arranged to convert thermal energy into electrical energy.

7. A tyre monitor as claimed in claim 1, further comprising an energy storage device.

8. A tyre monitor as claimed in claim 7, in which the energy storage device includes at least one battery.

9. A tyre monitor as claimed in claim 7, in which the energy storage device includes at least one capacitor.

10. A tyre monitor as claimed in claim 7, further comprising a wireless communication interface arranged to communicate with a device external to the sensor device.

11. A tyre monitor as claimed in claim 10, further comprising a power management module arranged to manage power between the energy harvester unit, the energy storage device, the wireless communication interface and the sensor.

12. A tyre monitor as claimed in claim 1, in which the sensor comprises a pressure sensor for measuring the internal pressure of a tyre.

13. A tyre monitor as claimed in claim 12, further comprising a temperature sensor arranged to measure a temperature within a tyre.

14. A tyre monitor as claimed in claim 1, further comprising a resiliently flexible housing substantially surrounding the sensor device, the housing comprising an elastic material and the tyre monitor being able to move freely when installed in a tyre.

15. A tyre monitor as claimed in claim 1, in which the sensor device is fixedly attached to a movable retaining ring configured to be movably attached to a circumferential surface of the wheel such that relative circumferential movement between the movable mounting band and the wheel is permitted.

16. A tyre monitor as claimed in claim 1, in which the sensor device is retained on a ring having spaced end portions, the ring being resiliently radially biased.

17. A tyre monitor as claimed in claim 15, in which the energy harvesting unit is arranged on the retaining ring at a location spaced from the sensor device.

18. A wheel assembly including a tyre monitor as claimed in claim 1.

19. A kit of parts comprising a tyre monitor as claimed in claim 1 and a reader external to the tyre monitor, wherein the sensor device and the reader are configured to communicate with each other.

20. An aircraft including a wheel assembly and a tyre monitor as claimed in claim 1.

21. An aircraft including a plurality of wheel assemblies and a plurality of tyre monitors as claimed in claim 1, each tyre monitor being associated with a different respective wheel assembly.
